(19) United States
(12) Patent Application Publication
(10) Pub. No.: US 2017/0185273 A1
(43) Pub. Date: Jun. 29, 2017

(54) Time Axis Responsiveness In Charts

(71) Applicant: SAP SE, Walldorf (DE)

(72) Inventors: Cathie MARACHE-FRANCISCO, Cannes (FR); Evian ZHU, Shanghai (CN); Irene HUANG, Shanghai (CN); Oliver ZHU, Shanghai (CN); Alex Su, Shanghai (CN)

(21) Appl. No.: 14/979,473

(22) Filed: Dec. 27, 2015

(51) Int. Cl. G06F 3/0484; G06F 17/21; G06F 3/0485; G06T 11/20; G06F 3/0482

(52) U.S. Cl. CPC G06F 3/04847; G06T 11/206; G06F 3/0482; G06F 3/04855; G06F 3/04845; G06F 17/212; G06F 2203/04806

(57) ABSTRACT

A computer-implemented method for rendering a chart and a time axis for the chart includes receiving a chart comprising time-series data, the time-series data including a start time input and an end time input, selecting one or more time levels based on the start time input and the end time input and based on a width of a display area for the chart, calculating a tick distribution for the time axis based on the selected time levels, where each time level includes one or more label display rules, determining one or more layers of labels to display on the time axis based on the selected time levels and the label display rules for the selected time levels and rendering the chart and the time axis for display in the display area using the calculated tick distribution for the time axis and including the selected time levels and determined labels.

### TECHNICAL FIELD

This description relates to time axis responsiveness in charts.

### BACKGROUND

Popular visualization solution providers provide support to display time information on the axis of a chart. The axis is usually displayed in a single layer to represent dates or year numbers. However, there are limitations with this type of time axis display. For example, the time axis may display only partial of the original information when it is under deeper level of time. For example, the user may be unable to tell year information about a graph simply by looking at the time axis. Also, the user may have limited ability to take control of the labels and levels to show in the visualization. Thus, current solutions do not support visualization of rich information for multiple levels. For instance, a current time axis may not provide visualization of the year, quarter and week at a same time.

### SUMMARY

In one general aspect, a computer-implemented method for rendering a chart and a time axis for the chart includes executing instructions stored on a non-transitory computer-readable storage medium. The method includes receiving a chart comprising time-series data, where the time-series data includes a start time input and an end time input. The method includes selecting one or more time levels from multiple time levels based on the start time input and the end time input of the time-series data and based on a width of a display area for the chart, calculating a tick distribution for the time axis based on the selected time levels, where each time level includes one or more label display rules, determining one or more layers of labels to display on the time axis based on the selected time levels and the label display rules for the selected time levels and rendering the chart and the time axis for the chart for display in the display area using the calculated tick distribution for the time axis and including the selected time levels and the determined labels.

In another general aspect, a computer program product for rendering a chart and a time axis for the chart is tangibly embodied on a non-transitory computer-readable storage medium and includes instructions that, when executed by at least one computing device, are configured to cause the at least one computing device to receive a chart comprising time-series data, where the time-series data includes a start time input and an end time input. The computing device is caused to calculate a tick distribution based on one or more time levels from multiple time levels using the start time input and the end time input, determine whether to render a time axis using a categorical time axis or a continuous time axis. The categorical time axis includes at least one label layer that defines a period of time and the continuous time axis includes at least one label layer that defines a point of time. The computing device is caused to render the chart and the time axis for the chart for display using the calculated tick distribution for the time axis and either the categorical time axis or the continuous time axis based on the determination of whether to render the categorical time axis or the continuous time axis.

In another general aspect, a system for rendering a chart and a time axis for the chart includes at least one memory including instructions and at least one processor that is operably coupled to the at least one memory and that is arranged and configured to execute the instructions that, when executed, cause the at least one processor to implement a time axis application. The time axis application is configured to receive a chart comprising time-series data, the time-series data including a start time input and an end time input, automatically select one or more time levels from multiple time levels based on the start time input and the end time input of the time-series data and based on a width of a display area for the chart, calculate a tick distribution for the time axis based on the selected time levels, where each time level includes one or more label display rules, determine one or more layers of labels to display on the time axis based on the selected time levels and the label display rules for the selected time levels and render the chart and the time axis for the chart for display in the display area using the calculated tick distribution for the time axis and including the selected time levels and the determined labels.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for rendering a chart and a time axis for the chart.

FIG. 2 is an example table of different time levels and format rules for each time level.

FIG. 3 is an example time axis having multiple layers of labels.

FIG. 4 is an example table illustrating different time levels, layer and label display combinations.

FIG. 5 is an example time axis illustrating label positioning with respect to a tick on the time axis.

FIG. 6 is an example time axis illustrating label positioning with respect to ticks on the time axis.

FIG. 7 is an example table illustrating responsive display rules.

FIG. 8 is an example time axis illustrating a categorical time axis.

FIG. 9 is an example time axis illustrating a continuous time axis.

FIG. 10 is an example flowchart illustrating example operations of the time axis application of FIG. 1.

FIG. 11 is an example flowchart illustrating example operations of the time axis application of FIG. 1.

FIG. 12 is an example flowchart for calculating the tick distribution.

FIG. 13 is an example flowchart for calculating tick spacings.

FIG. 14 is an example flowchart for obtaining the label to display on the time axis.

### DETAILED DESCRIPTION

This document describes systems and techniques for rendering a chart and a time axis for the chart. The chart and the time axis are rendered using a time axis application. The time axis application is designed to render a meaningful and customizable time axis to display all the information according to a user's desired input. The time axis application receives input regarding the data and the chart to be rendered along with user input and, based on the received input, calculates a time axis having time levels and labels. The time axis application renders the time axis and chart for display with in a designated display area.

The time axis application is configured to render and display both a categorical time axis and a continuous time axis. The time axis is responsive to changes in size of the display area and/or zoom input. In response to changes in size of the display area and/or the zoom input, the time axis application re-calculates the time levels and time labels, including appropriate spacing and intervals, and then re-renders the chart and the time axis using the recalculated information. The time axis application may access and rely on one or more rule sets to determine the best time axis to display for a high level of readability no matter what computing device is being used to view the displayed information.

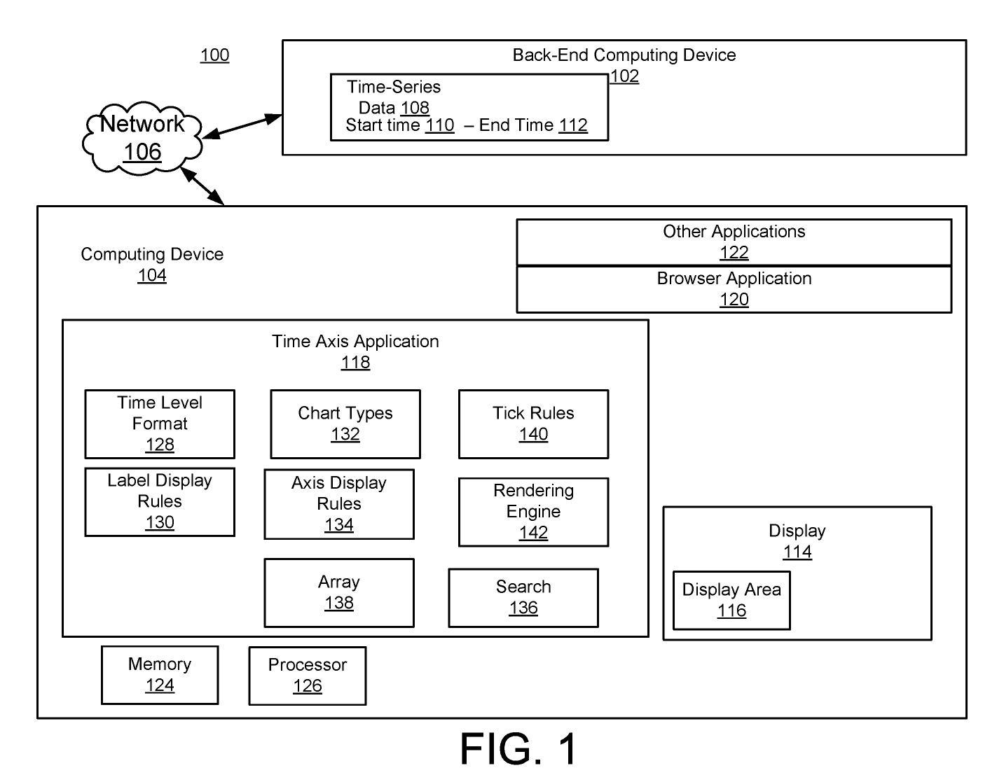

FIG. 1 is an example block diagram of a system 100 for rendering a chart and a time axis for the chart for display to a user. The system 100 includes at least one back-end computing device 102 and a computing device 104, which may communicate with each other through a network 106. The back-end computing device 102 may be implemented on any type of computing device such as a server, a desktop computer, a laptop computer, or any other type of computing device.

The back-end computing device 102 may include a database that stores information such as time-series data 108. The time-series data 108 may be stored in one or more formats and include information to define a chart for the time-series data. The time-series data 108 may include a start time 110 and an end time 112. The time-series data 108 may be stored on an in-memory database such as the SAP HANA cloud database.

The back-end computing device 102 may communicate with other computing devices such as the computing device 104 through the network 106. The network 106 may include a wired and/or wireless network such as the Internet. The back-end computing device 102 may communicate the time-series data 108 including the start time 110 and the end time 112 to the computing device 104 through the network 106.

The computing device 104 may include any type of computing device including a desktop computer, a laptop computer, a tablet, a smart phone or any other type of computing device. The computing device 104 includes a display 114. The display 114 may be used to display information rendered by other components of the computing device 104 including an operating system interface and one or more applications. The display 114 may include an area or a window for displaying a chart and its corresponding time axis. This area or window may be referred to as the display area 116 for the chart. The display area 116 may be implemented as part of one of the applications running on the computing device 104, which are discussed in more detail below.

The computing device 104 includes a time axis application 118, a browser application 120 and other applications 122. The computing device 104 includes at least one memory 124 and at least one processor 126, where the memory 124 may be a non-transitory computer-readable storage medium. Thus, the at least one processor 126 may represent two or more processors executing in parallel, and a non-transitory computer-readable storage medium 124 may represent virtually any non-transitory medium that may be used to store instructions for executing the components of the computing device 104. Multiple processors also may be referred to as multi-core processors or multi-processor core environment. The processor 126 may be a hardware processor, including a micro-processor.

The at least one processor 126 may be configured to execute instructions stored on the computer-readable storage medium 124 that, when executed, cause the at least one processor 126 to implement the time axis application 118, the browser application 120 and the other applications 122. The time axis application 118 is configured to receive the time-series data 108 from the back-end computing device 102 through the network 106 and to render the chart and time axis, which represents the time-series data 108, within a display area 116 on the display 114. The time axis application 118 may work in conjunction with the browser application 120 and other applications 122 such that the time axis application 118 may prepare and render the chart and time axis within the browser application 120 and/or the other applications 122 on the display 114 within the display area 116. That is, the browser application 120 and the other applications 122 may be configured to include a display area 116 within those applications that are being rendered for display on the display 114. Separately, the time axis application 118 itself may include the display area 116 as part of its application and render the chart and the time axis directly in the display area 116 for the display 114 without relying on other applications.

The time axis application 118 receives a chart from the time-series data 108 including the start time 110 and the end time 112 as input to the time axis application 118. Additionally, the time axis application 118 may use a width of the display area 116 as input to the time axis application 118. Given this input information, which may include the start time 110, the end time 112 and/or the width of the display area 116, the time axis application 118 may select a type of time axis, one or more time levels from multiple time levels and one or more layers of labels to display on the time axis based on the selected time levels.

The time levels that may be displayed for any chart include a selection from nine time hierarchies. The nine time hierarchies include: year, half, quarter, month, week, day, hour, minute and second. The time axis application 118 includes the multiple time levels and formats for each of the levels in a time level format module 128. While nine time hierarchies are discussed here and their formats are provided as discussed below, other time hierarchies also may be implemented by the time axis application 118 and the time levels are not limited to those discussed and illustrated herein.

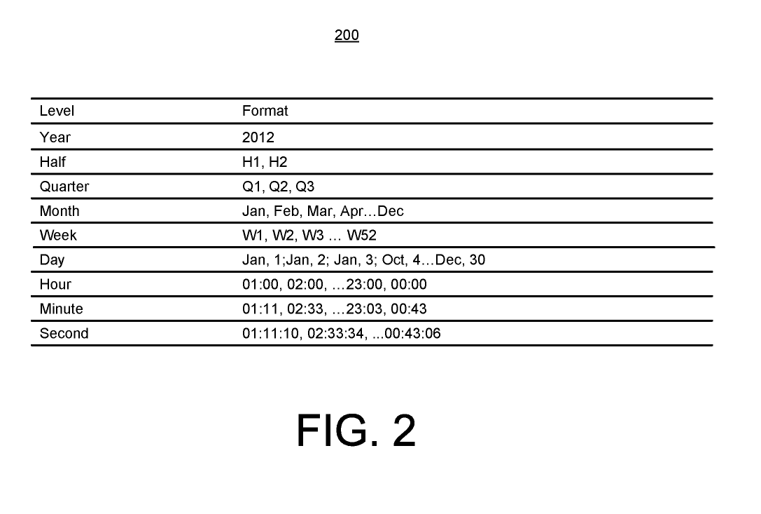

Referring to FIG. 2, an example table 200 illustrates the multiple time levels and format rules for each of the levels as stored in the time level format module 128 of FIG. 1. As illustrated in table 200, each level includes a format, which may be considered a default format. These default formats may be changed based on input received from a user through the time axis application 118. In this manner, the format of the time levels is configurable for each time level. However, the default time level format has been selected in order to provide an optimal viewing experience for the user.

Referring back to FIG. 1, the time axis application 118 may automatically select one or more time levels from the multiple time levels. Alternatively, the time axis application 118 may receive a selection of one or more time levels to display on the time axis from user input to the time axis application 118. The time axis application 118 displays the selected time levels using labels in a structured layer format on the time axis. In one implementation, the time axis application 118 may use a 3-layer structure to display the time information. Fewer layers may be used but in one implementation, no more than 3 layers may be displayed with any particular time axis.

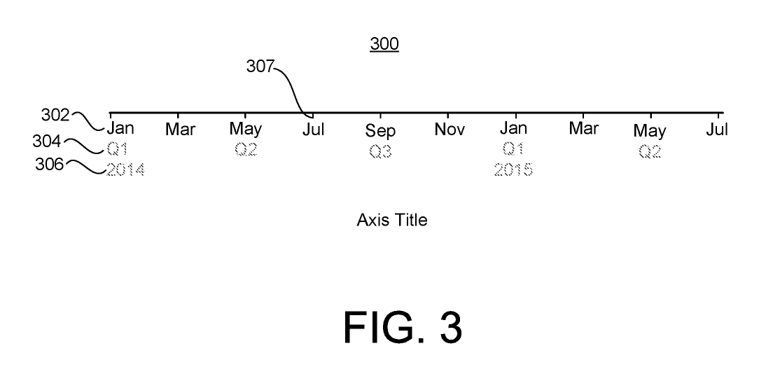

Referring to FIG. 3, an example time axis 300 illustrates the multi-layered approach to displaying the time information. In this example, the time axis 300 illustrates three layers on the time axis. The first layer 302 is closest to the time axis. The next layer 304 is below the first layer and the third layer 306 is the lowest layer and furthest from the time axis.

The time axis 300 displays the time levels on the time axis using ticks 307. In this example, ten ticks 307 are displayed along the time axis with each tick representing a point in time, which in this example is a particular month. The time axis application 118 calculates a tick distribution to determine a distance between two adjacent ticks and how many ticks to display along the time axis. The distance between two adjacent ticks is referred to as the tick distance unit (TDU). In one implementation, a default TDU is measured as about 32 pixels. The interval is defined as the number of time units (days, weeks, months, etc.) between two ticks 307. By default, the minimum interval is one but can be larger for example to show a tick on every two months. In the example time axis 300, the interval is two because the ticks go from January to March to May, etc. and thus are every two months.

Also, referring back to FIG. 1, the time axis application 118 includes label display rules 130. The label display rules 130 include multiple rules to determine what labels to show on each of the layers 302, 304, 306. One rule is that label values display on at most three layers. That is, the label display rules 130 include displaying no more than three layers of labels on the time axis 300. Another rule in the label display rules 130 is that the hour, minute and second time levels are displayed together in the same layer. Also, month and date are displayed together in the same layer.

The label display rules 130 also include a rule indicating that the smallest time level is displayed on the first layer, the second smallest time level is displayed on the second layer and the other time levels are displayed on the third layer in sequence and separated by an indicator, such as a slash. In reference to FIG. 3, it can be seen that the first layer 302 includes the smallest time level of month. The second layer 304 includes the next smallest time level of a quarter and the third layer 306 includes the largest time level.

In one implementation, the label display rules 130 also includes a rule that labels on the second and the third layers are displayed different from the labels on the first layer. For example, in one implementation, the labels on the second and the third layers may be displayed in a lighter color font such as gray. With reference to FIG. 3, it can be seen that the labels on layer 2 304 and layer 3 306 are in a lighter font than the label on the first layer 302. In this manner, it is easier for the viewer to read the labels on the time axis. It is understood that other indicators may be used to distinguish the labels on different layers other than font coloring or shading. Also, it is understood that other rules may be applied and/or configured to be applied or added to the label display rules 130 in addition to the rules discussed above.

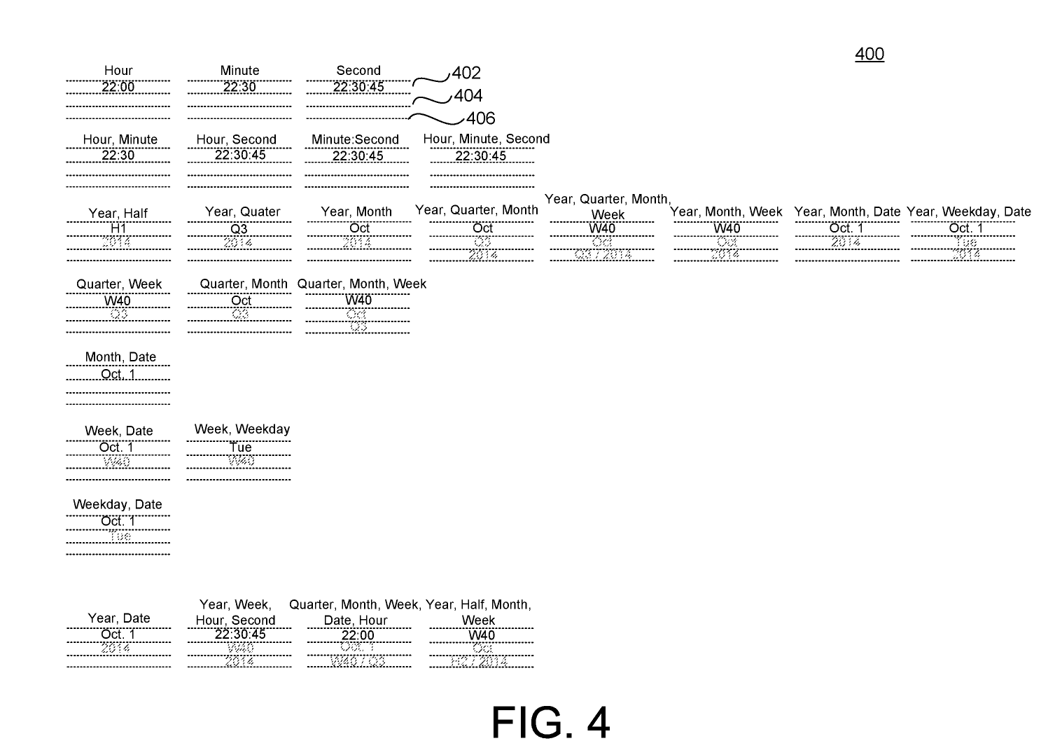

FIG. 4 illustrates an example table 400 showing different time level, layer and label display combinations according to the label display rules 130. Table 400 illustrates 26 different examples of one or more selected time levels and the layer and labels where the selected time levels would be illustrated on a time axis. For example, each of the different time level, layer and label combinations illustrate the time level and the label being on one of three possible layers namely, a first layer 402, a second layer 404 and a third layer 406. When there is just one time level to be illustrated on the time axis, then the label for the time level always appears on the first layer 402. Also, as discussed in the rules above the hour, minute and second time levels are all displayed together in the same layer. If the hour, minute and second time levels are selected and displayed and they are the only time levels, then they all appear in the first layer 402.

It is understood without discussing all 26 different examples how the selected time levels would be displayed with their label on a particular layer. Also, it is understood that these are merely examples in conformance with the rules discussed above and that other label display rules may be added and/or the current label display rules may be changed which would affect the layout of the time levels and their labels on the various layers.

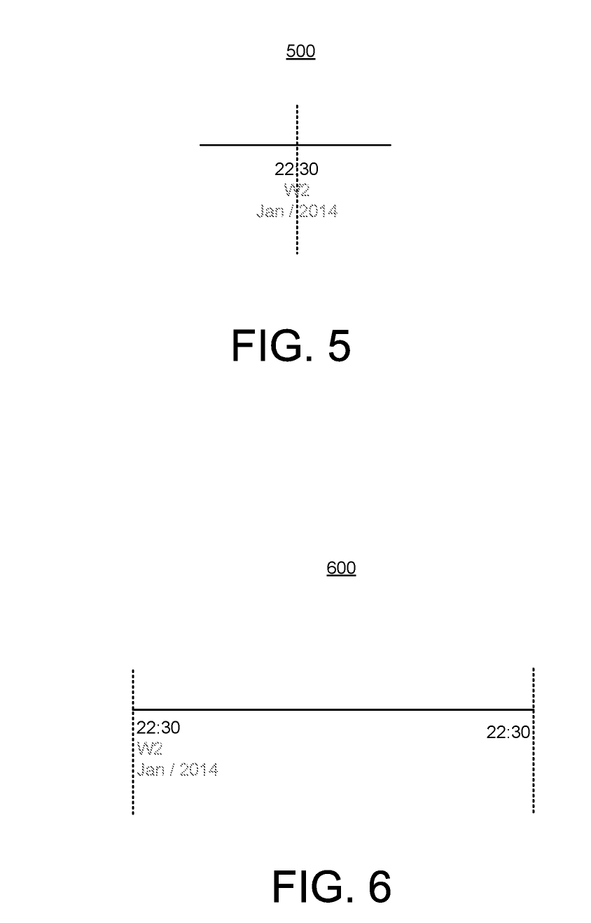

Referring back to FIG. 1, the label display rules 130 also include rules regarding label positioning with respect to the ticks on the time axis. In one implementation, by default, labels align to the center of each tick. Referring to FIG. 5, an example time axis 500 illustrates label positioning with respect to a tick on the time axis 500. The time axis 500 illustrates the default label positioning with respect to the tick where the labels are aligned to the center of each tick.

Referring to FIG. 6, an example time axis 600 illustrates the scenario where the labels are aligned to the border. The labels are aligned to the border because the label is near the border of the time axis. To remove information redundancy of the second and third layers, the second and third layers may be hidden if they would otherwise have the same information with the previous label.

The label display rules 130 also may include responsive display rules for each different time level. That is, each of the nine hierarchical time levels may include their own responsive display rules. As with the other rules discussed above, default rules may be configured and applied for each of the time levels. However, the responsive display rules also may be configurable based on user preferences that may be input into the time axis application 118.

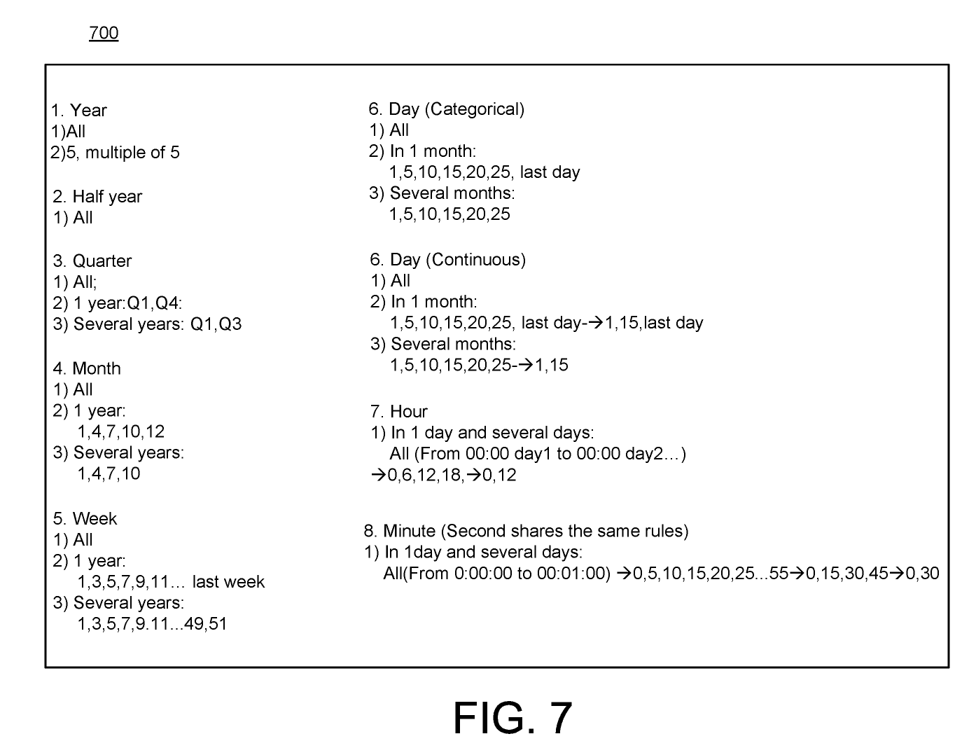

Referring to FIG. 7, an example table 700 illustrates example responsive display rules. Each of the nine time levels include one or more responsive display rules that provide rules as to how the time level labels will be displayed on the time axis. The responsive rules in different levels is simplified for a couple of reasons. First, it makes it simple and clear to keep the most common cases with business meaning. Also, in a categorical time axis, which is discussed in more detail below, it is desirable to make the label to stand in the middle of the time block and not stand outside of the block, which can create confusion for the viewer or user.

In table 700, each time level shows below it the layer and the rule for the layer for that time level. For example, for the year time level when the year is displayed on the first layer all years are shown. When the year is shown in the second layer the years are displayed in multiples of 5. For the half-year, when the half-year is displayed in the first layer, then all half-year labels are displayed. The rest of the chart follows in similar order and illustrates and describes the rule for the time level to follow depending on the layer in which it is to be displayed on the time axis. It is understood that table 700 is merely an example of default responsive display rules and that the rules may be configured and or modified as appropriate.

Referring back to FIG. 1, the time axis application 118 includes a chart type module 132. The chart type module 132 includes multiple different types of charts in which to display the time-series data 108. In many cases, a default chart type may be selected by the time axis application 118 based on the time-series data 108. In other implementations, the chart type may be selected by a user and a user interface may be provided to enable the user to select the particular chart type.

Chart types may include line, scatter, bubble, column, stacked column, column plus line, stacked column plus line, vertical bullet, dual axis, waterfall and area. Other chart types also may be provided for selection from the chart type module 132. For all of the different chart types, there may be only two types of time axis looks that are selected and displayed for all of the different chart types. That is, while many different chart types may be selected for display of the time-series data, the time axis displayed for each of these charts may follow the same rules and functionality described in this document for both time axis types. In this manner, there are not different time axis for each different chart type.

The time axis application 118 may select from one of two different time axis types. The first type of time axis is a categorical time axis, where the label always stands for a period of time. The time axis may be displayed using the categorical time axis if the time level is not the smallest time level and if the time level is within the year, half year, quarter, month, week or day. If these two conditions are satisfied, then the time axis application selects the categorical time axis type. The rules and types of axis may be stored in the axis display rules module 134.

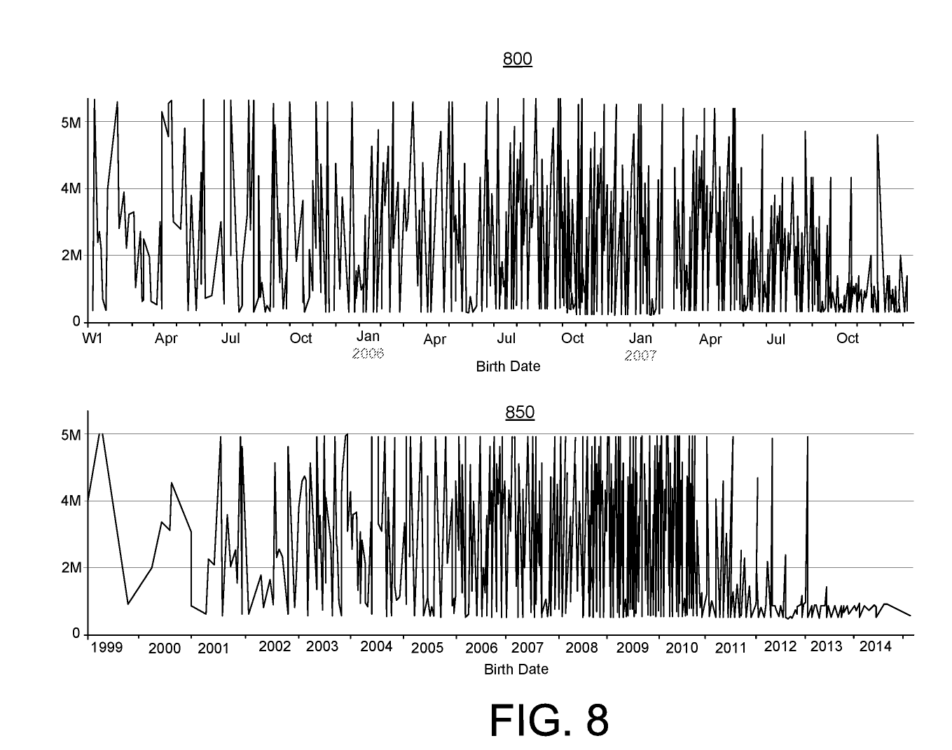

Referring to FIG. 8, two example categorical time axis charts are illustrated. The first time axis 800 illustrates time-series data in a categorical time axis, where the month time level is on a first layer and the year time level is on a second layer. The month time level in this example stands for a period of time and not for a point of time. The second time axis 850 illustrates time-series data in a categorical time axis, where the year time level is on a first layer. The year time level in this example stands for a period of time and not for a point of time.

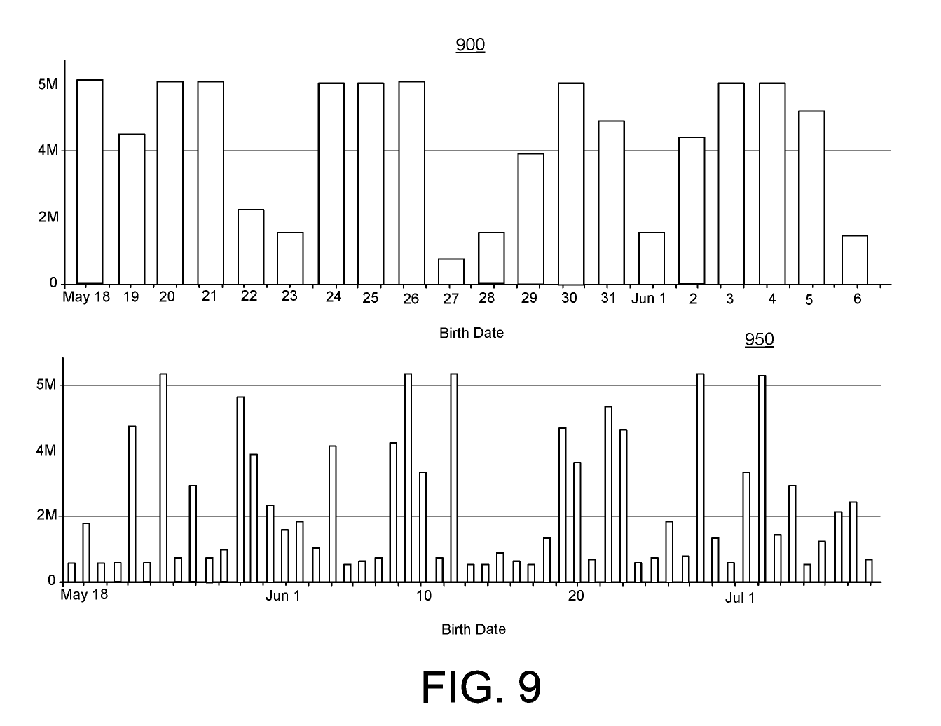

Referring to FIG. 9, two example continuous time axis charts are illustrated. The time axis application 118 determines when to display the axis as a continuous time axis if the time level is the smallest time level or if the time level is within our, minute, or second. In FIG. 9, the time axis 900 illustrates time-series data in a continuous time axis where each time level stands for a point in time. Each day of the month in the time axis stands for one point in time. In the second time axis 950, again the time level represents a point in time where each day of the month represents a point in time.

The time axis application 118 also includes a search module 136, an array 138, tick rules 140 and a rendering engine 142. The search module 136, the array 138 and the tick rules 140 all may be used to help calculate the tick distribution for the time axis. The tick rules 140 may include rules such that the best distance between two adjacent ticks is 2.5 TDUs. Furthermore, the distance between two adjacent ticks should be within the range of one TDU to three TDUs. Finally, at least two ticks should be visible. The rules laid out in the tick rules 140 help to achieve the best tick distribution for the time axis, whether it's a categorical time axis or a continuous time axis.

The time axis application 118 selects one or more time levels from the multiple time levels based on the start time input and the end time input of the time-series data and based on a width of a display area 116 for the chart. The time axis application 118 calculates a ticket distribution according to the tick rules 140 and the time axis based on the selected time levels, where each time level includes one or more label display rules 130. The time axis application 118 determines one or more layers of labels to display on the time axis based on the selected time levels and the label display rules for the selected time levels. Then, the time axis application uses the rendering engine 142 to render the chart and the time axis for the chart for display in the display area 116 using the calculated tick distribution for the time axis and including the selected time levels and the determined labels.

The time axis application 118 may re-calculate and re-render the time axis and the chart in the display area 116 based on input received that causes a zoom in or a zoom out of a portion of the chart. The time axis application 118 also may recalculate and re-render the time axis and the chart in the display area 116 based on input received that causes a change in the display area 116. For example, if the width of the display area 116 changes, then the time axis application 118 re-renders the time axis and the chart after recalculating the tick distribution and the time levels and labels to display on the time axis. The time axis application 118 also determines whether to render the time axis using a categorical time axis or a continuous time axis and uses the axis display rules 134 to make this determination.

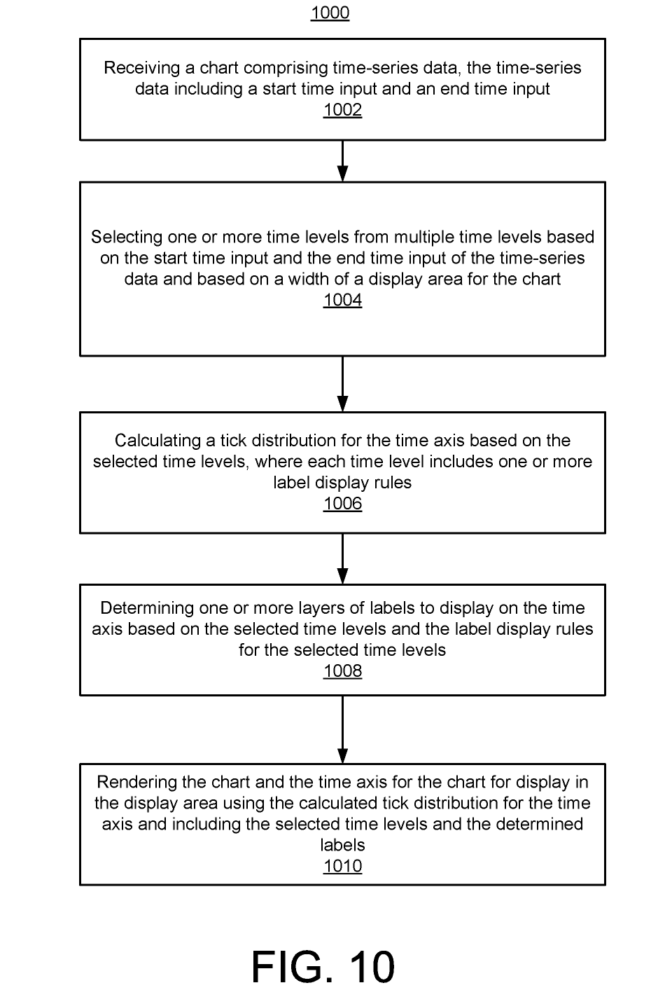

Referring to FIG. 10, an example process 1000 illustrates example operations of the time axis application 118 of FIG. 1. Process 1000 includes receiving a chart including time-series data where the time-series data includes a start time input and an end time input (1002). For example, the time axis application 118 receives the start time 110 and the end time 112 along with the chart having the time-series data 108.

Process 1000 includes selecting one or more time levels from multiple time levels based on the start time input and the end time input of the time-series data and based on a width of a display area for the chart (1004). For example, the time axis application 118 selects one or more time levels from the time level format module 128 based on the start time 110 and the end time 112 of the time-series data 108 and the width of the display area 116 for the chart.

Process 1000 includes calculating a tick distribution for the time axis based on the selected time levels, where each time level includes one or more label display rules (1006). For example, the time axis application 118 calculates the tick distribution for the time axis based on the selected time levels from the time level format module 128 using the tick rules 140, the array 138 and the search module 136. As discussed above, each time level includes one or more labels display rules from the label display rules 103.

Process 1000 includes determining one or more layers of labels to display on the time axis based on the selected time levels and the label display rules for the selected time levels (1008). For example, the time axis application 118 determines the layers of labels to display on the time axis based on the selected time levels and the label display rules 130 for the selected time levels.

Next, process 1000 includes rendering the chart and the time axis for the chart for display in the display area using the calculated tick distribution for the time axis and including the selected time levels and the determined labels (1010). For example, the time axis application 118 uses the rendering engine 142 to render the chart and the time axis for the chart in the display area 116 using the calculated tick distribution for the time axis including the selected time levels and the determined labels.

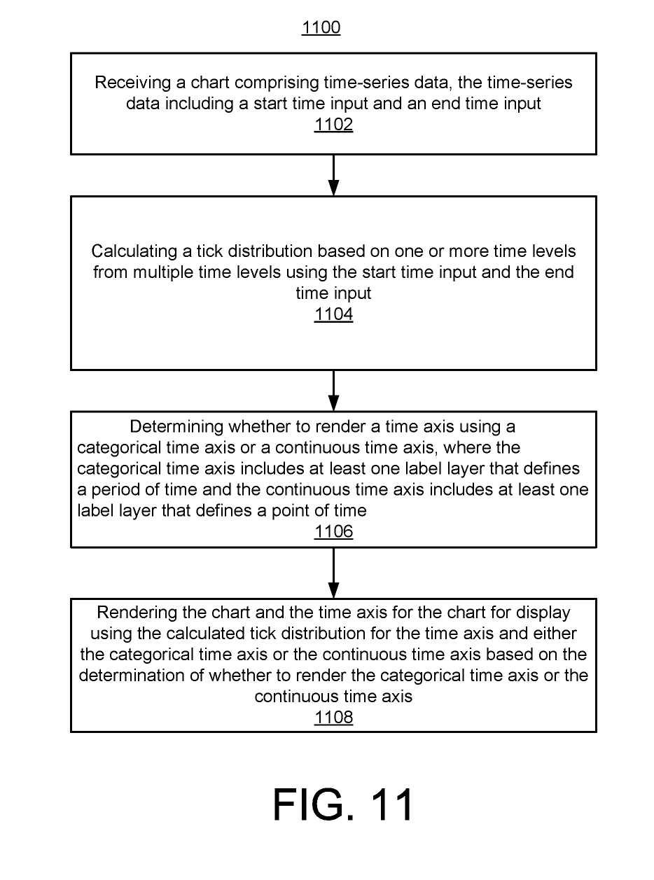

Referring to FIG. 11, an example process 1100 illustrates example operations of the time axis application 118. Process 1100 includes receiving a chart including time-series data, where the time-series data includes a start time input and an end time input (1102). For example, the time axis application 118 receives the start time 110 and the end time 112 along with the chart having the time-series data 108.

Process 1100 includes calculating a tick distribution based on one or more time levels from multiple time levels using the start time input and the end time input (1104). For example, the time axis application 118 calculates the tick distribution for the time axis based on the time levels from the time level format module 128 using the tick rules 140, the array 138 and the search module 136.

In this example process 1100, the time axis application 118 then determines whether to render a time axis using a categorical time axis or a continuous time axis, where the categorical time axis includes at least one label layer that defines a period of time and the continuous time axis includes at least one label layer that defines a point of time (1106). The time axis application 118 uses the axis display rules 134 to determine whether to render the time axis using a categorical time axis or a continuous time axis.

Next, process 1100 includes rendering the chart and the time axis for the chart for display using the calculated tick distribution for the time axis and either the categorical time axis or the continuous time axis based on the determination of whether to render the categorical time axis or the continuous time axis (1108). For example, the time axis application 118 uses the rendering engine 142 to render the chart and the time axis for the chart for display using the calculated tick distribution for the time axis and either the categorical time axis or the continuous time axis.

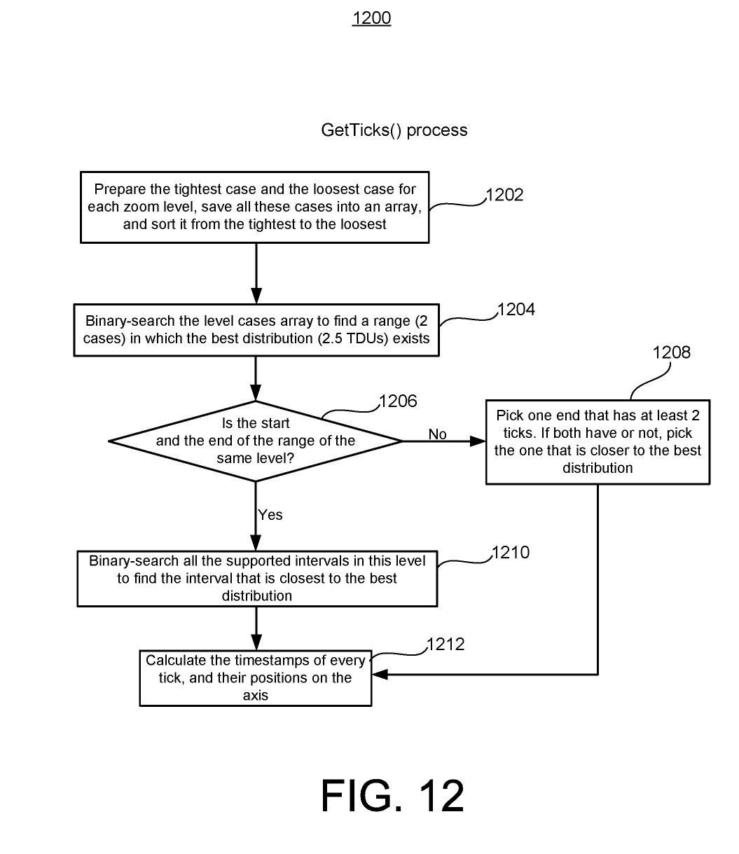

Referring to FIG. 12, an example flowchart illustrates an example process 1200 for calculating the tick distribution. Process 1200 may be performed by the time axis application 118 of FIG. 1. Process 1200 includes preparing the tightest case and the loosest case for each zoom level and save all these cases into an array 138 and sort the array from the tightest to the loosest (1202). Next, process 1200 includes performing a binary-search 136 of the cases in the array 138 to find a range (e.g., 2 cases) in which the best tick distribution (e.g., 2.5 TDUs) exists (1204).

Then, process 1200 determines whether the start and the end of the range are of the same level (1206). If they are not of the same level, then the time axis application 118 picks one end that has at least 2 ticks (1208). If both have at least 2 ticks or neither has at least 2 ticks, then the time axis application 118 picks the one that is closer to the best distribution (1208). Then, process 1200 calculates the timestamps of every tick and their positions on the axis (1212).

If the start and the end of the range are of the same level, then the time axis application 118 conducts a binary-search 136 of all the supported intervals in this level to find the interval that is closest to the best distribution (1210). Then, process 1200 calculates the timestamps of every tick and their positions on the axis (1212).

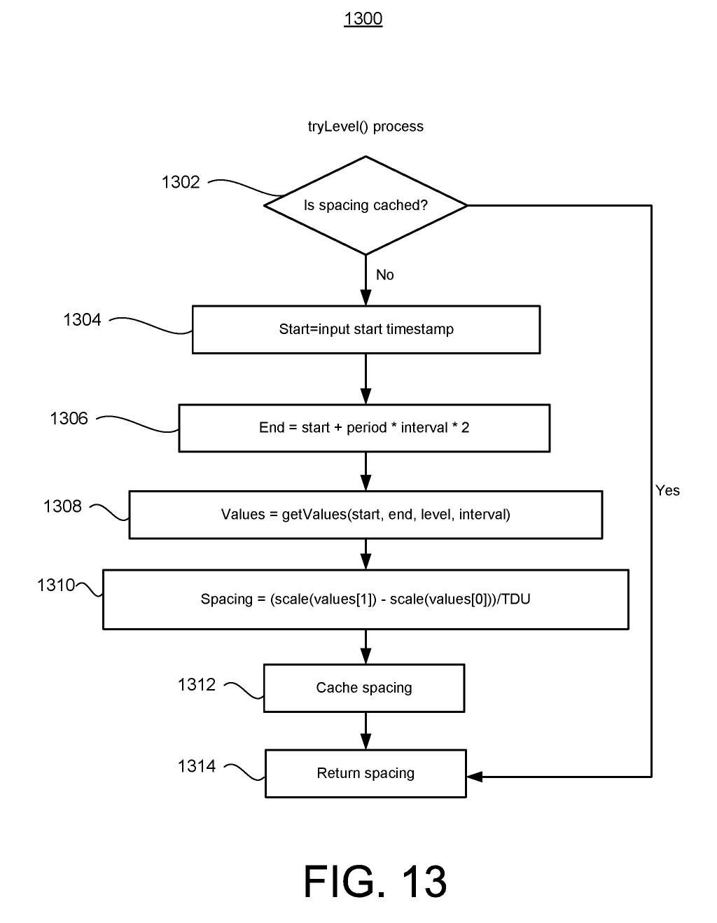

When doing a binary search on levels or intervals, a “tryLevel” process may be used to quickly calculate the tick spacings. Instead of getting every tick, the “tryLevel” process calculates the distance between the first two ticks. Referring to FIG. 13, an example process 1300 illustrates the “tryLevel” process. The process 1300 may be performed by the time axis application 118 of FIG. 1.

Process 1300 determines if the spacing is cached (1302). The time axis application 118 may determine if the spacing is cached. The spacing may be cached in the array 138 or other storage or memory module. If this spacing is cached, then process 1300 simply returns the spacing (1314) from the cache.

If the spacing was not cached, then process 1300 proceeds to determine the spacing. The Start is equal to the input start timestamp (1304). The End is equal to the start plus the period times the interval times 2 (1306). The values equal a getValues call where getValues(start, end, level, interval) (1308). The spacing is then calculated by (scale(values[1])−scale(values[0]))/TDU (1310). Once the spacing is calculated, then the spacing is cached (1314) and the spacing is returned (1314) for implementation and rendering on the time axis.

In process 1300, the “period” may be a constant for every level. It means the milliseconds of one time level (a second, an hour, a day, a month, etc.). For example, the “period” of a second is 1000. The “getValues” process in step (1308) calculates every timestamp of a given level and given interval from start to end. For some special levels and intervals, the result timestamps must be divisible by the interval. For instance, if the level is “minute” and the interval is 15, then only 0 m, 15 m, 30 m and 45 m are acceptable results. Similar rules apply to “second”, “hour”, “month” and “year”.

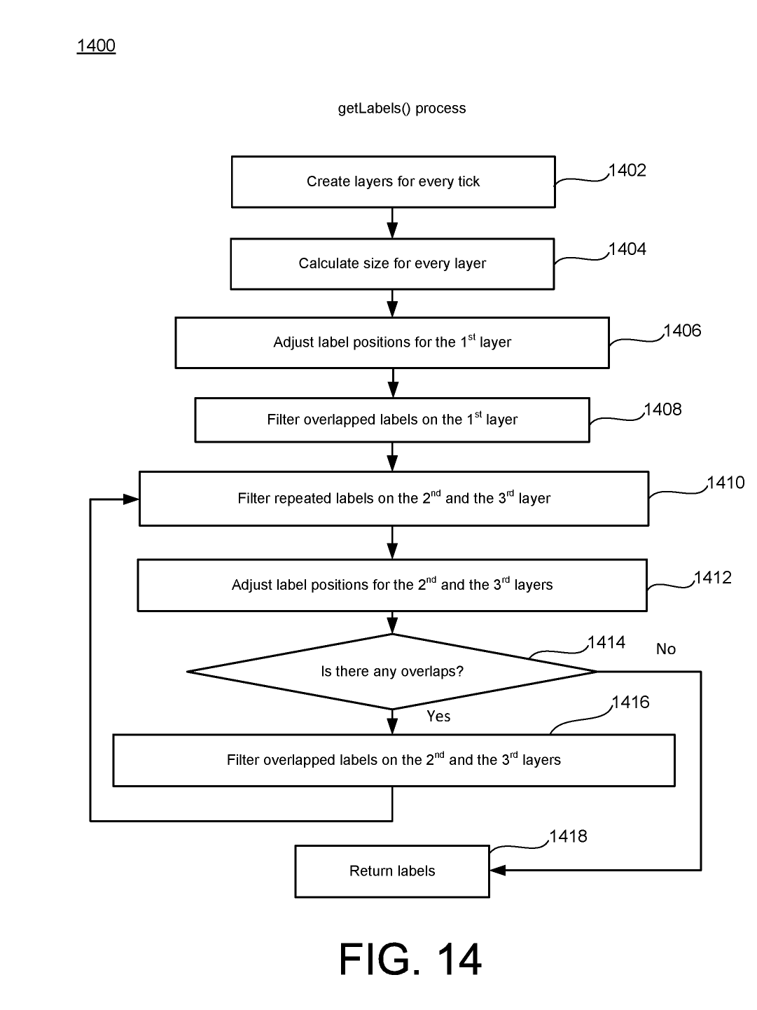

Referring to FIG. 14, an example process 1400 illustrates an example process to get the labels for the time axis. Process 1400 may be performed by the time axis application 118 of FIG. 1. Process 1400 includes creating layers for every tick (1402) and calculating the size for every layer (1404). The label positions are adjust for the first layer (1406) and the overlapped labels are filtered on the first layer (1408).

Then, process 1400 filters repeated labels on the second layer and the third layer (1410). The label positions are adjusted for the second layer and the third layer (1412). Process 1400 determines if there are any overlaps (1414). If there are no overlaps, then the labels are returned (1418) for rendering on the time axis. If there are overlaps, then process 1400 filters the overlapped labels on the second layer and the third layer (1416) and then returns to step 1410 in the process.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for rendering a chart and a time axis for the chart including executing instructions stored on a non-transitory computer-readable storage medium, the method comprising:
receiving a chart comprising time-series data, the time-series data including a start time input and an end time input;
selecting one or more time levels from multiple time levels based on the start time input and the end time input of the time-series data and based on a width of a display area for the chart;
calculating a tick distribution for the time axis based on the selected time levels, wherein each time level includes one or more label display rules;
determining one or more layers of labels to display on the time axis based on the selected time levels and the label display rules for the selected time levels; and
rendering the chart and the time axis for the chart for display in the display area using the calculated tick distribution for the time axis and including the selected time levels and the determined labels.

2. The method of claim 1 wherein selecting the one or more time levels comprises receiving a user-input selection of the one or more time levels.

3. The method of claim 1 wherein calculating the tick distribution for the time axis comprises selecting the tick distribution from among multiple possible tick distributions, wherein the selected tick distribution includes a spacing between two adjacent ticks of between one tick distance unit and three tick distance units, wherein a tick distance unit is about thirty two pixels.

4. The method of claim 1 wherein calculating the tick distribution for the time axis comprises:
preparing a tightest case and a loosest case for each zoom level;
saving the prepared cases in an array;
sorting the array from the tightest case to the loosest case;
searching the array to determine a range of levels in which a best tick distribution exists, wherein each level includes one or more intervals, wherein an interval defines a number of time units between two ticks;
searching the intervals to find the interval that is closest to the best tick distribution; and
calculating timestamps of each tick and position of each tick on the time axis.

5. The method of claim 1 further comprising determining whether to render the time axis using a categorical time axis or a continuous time axis, wherein:
the categorical time axis includes at least one of the labels that defines a period of time; and
the continuous time axis includes at least one of the labels that defines a point of time.

6. The method of claim 1 further comprising:
receiving a zoom input;
automatically re-calculating the tick distribution in response to receiving the zoom input;
automatically re-determining the layers of labels to display; and
automatically re-rendering the chart and the time axis for the chart for display in the display area using the re-calculated tick distribution for the time axis and including the selected time levels and re-determined labels.

7. The method of claim 1 wherein the label display rules comprise:
displaying no more than three layers of labels on the time axis;
displaying a smallest time label on a first layer closest to the axis; and
displaying a next smallest time label on a second layer.

8. A computer program product for rendering a chart and a time axis for the chart, the computer program product being tangibly embodied on a non-transitory computer-readable storage medium and comprising instructions that, when executed by at least one computing device, are configured to cause the at least one computing device to:
receive a chart comprising time-series data, the time-series data including a start time input and an end time input;
calculate a tick distribution based on one or more time levels from multiple time levels using the start time input and the end time input;
determine whether to render a time axis using a categorical time axis or a continuous time axis, wherein
the categorical time axis includes at least one label layer that defines a period of time, and
the continuous time axis includes at least one label layer that defines a point of time; and
render the chart and the time axis for the chart for display using the calculated tick distribution for the time axis and either the categorical time axis or the continuous time axis based on the determination of whether to render the categorical time axis or the continuous time axis.

9. The computer program product of claim 8 wherein the instructions include instructions that, when executed by the computing device, are configured to cause the computing device to:
select the one or more time levels from the multiple time levels based on the start time input and the end time input and based on a width of a display area for the chart.

10. The computer program product of claim 9 wherein the instructions that, when executed by the computing device, are configured to cause the computing device to select the one or more time levels include instructions that, when executed by the computing device, are configured to cause the computing device to:
receive a user-input selection of the one or more time levels.

11. The computer program product of claim 9 wherein each time level includes one or more label display rules and wherein the instructions include instructions that, when executed by the computing device, are configured to cause the computing device to:
determine one or more layers of labels to display on the time axis based on the selected time levels and the label display rules for the selected time levels; and
render the chart and the time axis using the selected time levels and the determined labels.

12. The computer program product of claim 11 wherein the label display rules comprise:
displaying no more than three layers of labels on the time axis;
displaying a smallest time label on a first layer closest to the axis; and
displaying a next smallest time label on a second layer.

13. The computer program product of claim 8 wherein the instructions include instructions that, when executed by the computing device, are configured to cause the computing device to:
receive a zoom input;
automatically re-calculate the tick distribution in response to receiving the zoom input; and
automatically re-render the chart and the time axis for the chart for display using the re-calculated tick distribution for the time axis.

14. A system for rendering a chart and a time axis for the chart, the system comprising:
at least one memory including instructions; and
at least one processor that is operably coupled to the at least one memory and that is arranged and configured to execute the instructions that, when executed, cause the at least one processor to implement a time axis application, wherein
the time axis application is configured to:
receive a chart comprising time-series data, the time-series data including a start time input and an end time input;
automatically select one or more time levels from multiple time levels based on the start time input and the end time input of the time-series data and based on a width of a display area for the chart;
calculate a tick distribution for the time axis based on the selected time levels, wherein each time level includes one or more label display rules;
determine one or more layers of labels to display on the time axis based on the selected time levels and the label display rules for the selected time levels; and
render the chart and the time axis for the chart for display in the display area using the calculated tick distribution for the time axis and including the selected time levels and the determined labels.

15. The system of claim 14 wherein the time axis application is configured to:
receive input changing the width of the display area for the chart;
re-select the one or more time levels in response to the changed width;
re-calculate the tick distribution for the time axis based on the re-selected time levels;
re-determine the one or more layers of labels to display; and
re-render the chart and the time axis for the chart for display in the display area using the re-calculated tick distribution for the time axis including the re-selected time levels and the re-determined labels.

16. The system of claim 14 wherein the time axis application is configured to:
receive a zoom input;
re-select the one or more time levels in response to the zoom input;
re-calculate the tick distribution for the time axis based on the re-selected time levels;
re-determine the one or more layers of labels to display; and
re-render the chart and the time axis for the chart for display in the display area using the re-calculated tick distribution for the time axis including the re-selected time levels and the re-determined labels.

17. The system of claim 14 wherein the label display rules comprise:
displaying no more than three layers of labels on the time axis;
displaying a smallest time label on a first layer closest to the axis; and
displaying a next smallest time label on a second layer.

18. The system of claim 14 wherein the time axis application is configured to calculate the tick distance such that at least two ticks are visible.

19. The system of claim 14 wherein the time axis application is configured to:
calculate an interval between a first two ticks; and
apply the calculated interval to all of the ticks on the time axis.

20. The system of claim 14 wherein the time axis application is configured to:
automatically select and fix the time levels; and
display a scroll bar in response to selecting and fixing the time levels.
